(19) United States
(12) Patent Application Publication
(10) Pub. No.: US 2008/0002219 A1
(43) Pub. Date: Jan. 3, 2008

(54) Printer to display job request information via bluetooth and a method of displaying job request information in the printer

(75) Inventor: Jun-hyung Ha, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/605,404

(22) Filed: Nov. 29, 2006

(30) Foreign Application Priority Data
Jun. 29, 2006 (KR) 2006-59242

(51) Int. Cl. B41B 1/02

(52) U.S. Cl. 358/1.15

(57) ABSTRACT

A printer to display job request information via Bluetooth and a method of displaying job request information in the printer capable of preventing an undesired job operation by providing information on a Bluetooth profile and information on a job request status are provided. The printer includes a Bluetooth connector to connect the printer with a host via Bluetooth, a profile analyzer to analyze a Bluetooth profile used for connection with the host, a profile handler to handle an operation of the Bluetooth profile and determining a job status according to a corresponding profile, a display unit to display information of the profile analyzed by the profile analyzer and the job status according to the corresponding profile determined by the profile handler, and a controller to control the Bluetooth connector, the profile analyzer, the profile handler, and the display unit.

### CROSS-REFERENCE TO RELATED APPLICATION

This application claims the benefit of Korean Application No. 2006-59242, filed Jun. 29, 2006 in the Korean Intellectual Property Office, the disclosure of which is incorporated herein by reference.

### BACKGROUND OF THE INVENTION

1. Field of the Invention

An aspect of the present invention relates to a printer to display job (for example, printing) request information and a method of displaying the job request information in the printer, and, more particularly, to a printer to display the job request information via Bluetooth and a method of displaying the job request information in the printer that is capable of preventing an undesired job operation by providing information on a Bluetooth profile and information on a job request status.

2. Description of the Related Art

As mobile phones or personal digital assistants (PDA) have become popular, demand for devices that provide for an interface between mobile devices and other devices has increased. Bluetooth is a wireless specification that provides for a particular interface between various devices that have already been commercialized and are proven to be stable and compatible. In general, according to Bluetooth protocols, when two or more Bluetooth enabled devices are near each other, the Bluetooth devices are automatically recognized and connected. Each Bluetooth device can be identified by an identification number that is set in a Bluetooth module or chip and a user identification number that is input by a user.

FIG. 1 shows a structure of an existing printer. As shown in FIG. 1, the existing printer 100 includes a central processing unit (CPU) 110, a memory 120, a key panel 130, a display unit 140, a print engine unit 150, and a personal computer (PC) interface unit 160. The CPU 110 controls every part of the printer 100 according to a predetermined program stored therein. The memory 120 stores an operational program of the CPU 110, a general control program, and data obtained by performing a program of the CPU 110. The key panel 130 includes a plurality of keys and applies key data to the CPU 110 when the keys are pressed. The display unit 140 displays an operational status of a system of the printer 100 by using display data of the CPU 110. The print engine unit 150 prints data from the memory 120 or data transmitted from the PC interface unit 160. The PC interface unit 160 enables the print engine unit 150 to print the data by transmitting the print data received from the host 10 to the print engine unit 150.

According to the printing method using the existing printer, the registration and the certification of an unspecified user are respectively performed by a manipulation of the key panel 130 or by a server (not shown) connected through a network. The user is registered as a new user by using the key panel 130 mounted on the printer or using the server. Even when the user is registered, in order to print a predetermined print out such as a receipt or a notice, a predetermined procedure needs to be completed via the key panel 130. Then, a password has to be input or some other certification process has to be performed through the server connected to the printer.

However, according to the existing printing methods, an operator of the server connected to the printer needs to participate in the registration and the certification of the external device. In addition, when a print out with a predetermined format (such as a receipt or notice) is to be printed, the manipulation of the printer by the user is required.

In order to solve the aforementioned problem, a printing apparatus is required that is capable of checking whether an external device that requests that the printing apparatus prints via a Bluetooth protocol is registered in a database without a need for a manipulation by a user. Further, a printing apparatus that is also capable of outputting received data according to an output mode or outputting pre-stored data when the data is not received is required.

The conventional printing apparatus using Bluetooth including the aforementioned printing apparatus using Bluetooth provides only the information on printing via Bluetooth when a job (e.g., a printing job) is requested by the host. Therefore the user cannot determine whether undesired printing is requested.

When the conventional printing apparatus 100′ using Bluetooth, for example, as shown in FIGS. 1 and 2, receives the job request (i.e., a printing request) from the host 10′, such as a mobile phone, and performs printing, as shown in FIGS. 3 and 4, the information on the corresponding job (i.e., Bluetooth printing) is displayed on the display unit of the printing apparatus 100′. Accordingly, the user cannot determine which Bluetooth profile printing is requested.

### SUMMARY OF THE INVENTION

An aspect of the present invention provides a printer to display job request information via Bluetooth that is capable of preventing an undesired job operation by providing information on a Bluetooth profile and information on a status of a job request via Bluetooth.

An aspect of the present invention also provides a method of displaying the job request information via Bluetooth in the printer that is capable of preventing an undesired job operation by providing information on a Bluetooth profile and information on a job request status via Bluetooth.

According to an aspect of the present invention, there is provided a printer to display information on a job that has been requested to be performed by a host via Bluetooth, the printer comprising: a Bluetooth connector to connect the printer with the host via Bluetooth; a profile analyzer to analyze a Bluetooth profile used in the connection with the host; a profile handler to handle an operation of the Bluetooth profile and to determine a status of the job according to the profile; a display unit to display information on the profile and the status of the job; and a controller to control the Bluetooth connector, the profile analyzer, the profile handler, and the display unit.

According to the above described aspect of the present invention, the status of the job according to the corresponding profile determined by the profile handler may include information on a success or a failure of the job.

In addition, according to aspects of the invention, the profile may be one of a basic printing profile (BPP), a file transfer protocol (FTP), an object push profile (OPP), and a hardcopy cable replacement profile (HCRP). Here, BPP is a protocol used to transmit a command for printing in addition to a file to be printed, HCRP is a protocol used for printing through a printer driver instead of an existing printer port, and OPP is a protocol used for transmitting an object such as a name card or image file.

According to another aspect of the present invention, there is provided a method of displaying information on a job requested to be performed by a printer from a host via Bluetooth, the method including: allowing the printer to receive a connection request; allowing the printer to receive the job to be performed from the host when the printer is connected with the host via Bluetooth; allowing the printer to display the information on the job requested by the host or the information on a connection profile of the job requested by the host on a display unit of the printer; and allowing the printer to display information on a specific operation according to the profile on the display unit of the printer.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing a structure of a conventional printer;

FIG. 2 is a diagram showing a connection between a host and a printer via Bluetooth;

FIGS. 3 and 4 show a status displayed on a printer when a printing job is performed via Bluetooth in the related art;

FIG. 5 is a block diagram of a printer to display job request information via Bluetooth according to an embodiment of the present invention;

FIG. 6 is a flowchart of a method of displaying information in a printer for displaying job request information via Bluetooth according to an embodiment of the present invention;

FIG. 7 shows various embodiments of a connection profile of a corresponding job displayed on a display unit of a printer according to an embodiment of the present invention; and

FIG. 8 shows various embodiments of information on a specific operation according to a corresponding profile displayed on a display unit of a printer according to an embodiment of the present invention.

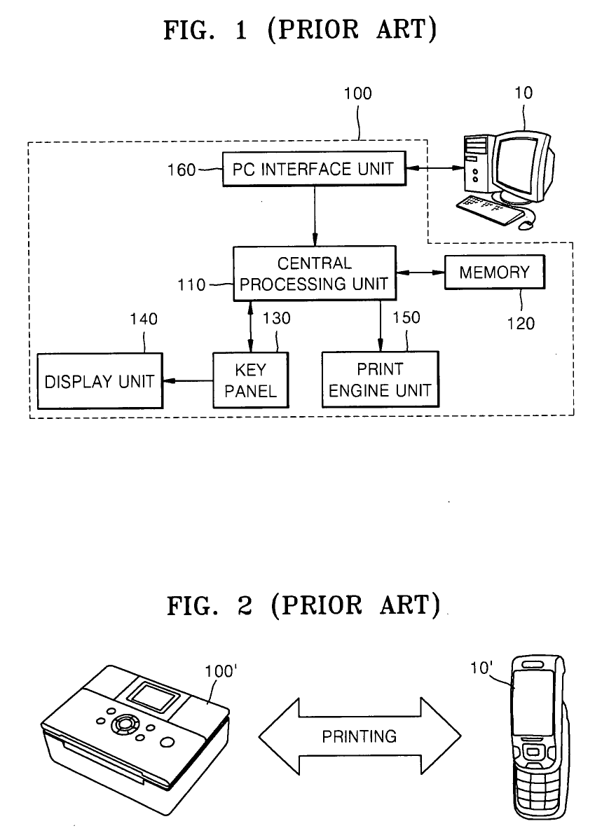

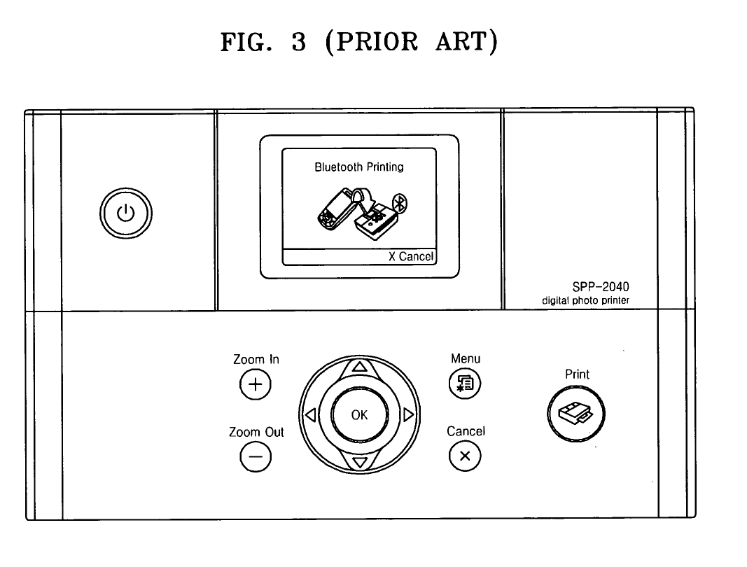

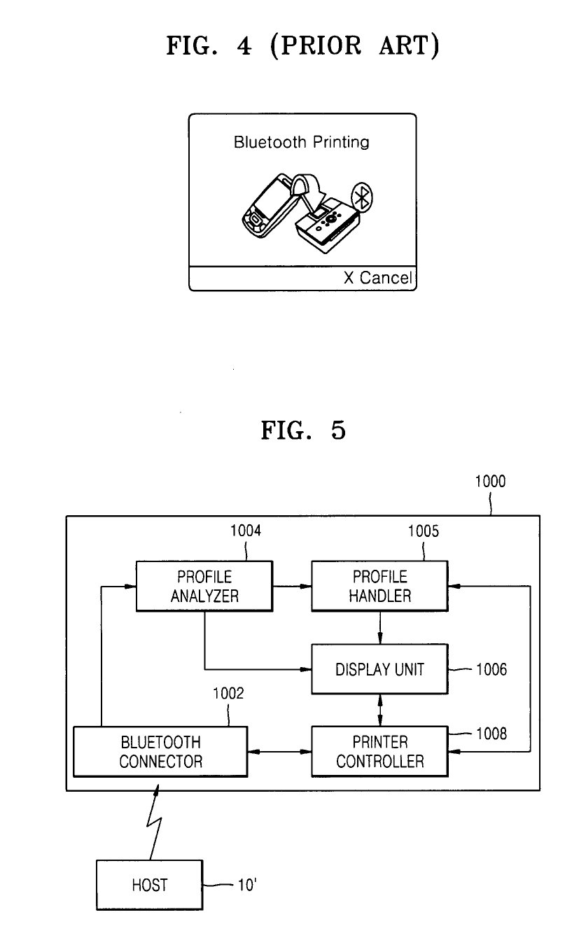

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, a printer for displaying job request information via Bluetooth and a method of displaying the job request information an a display unit of the printer according to an exemplary embodiment of the present invention will be described in detail with reference to the accompanying drawings.

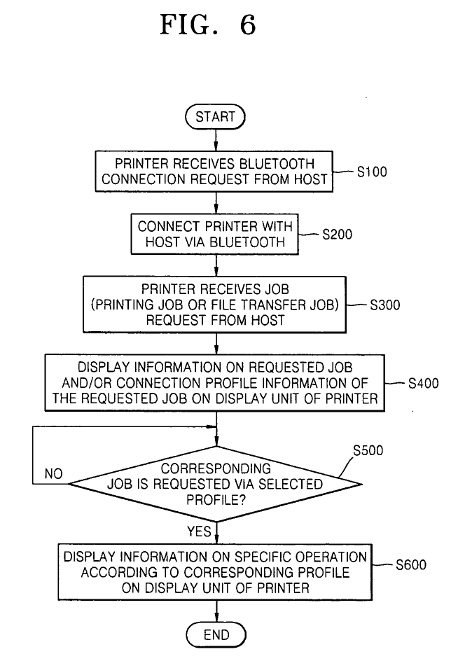

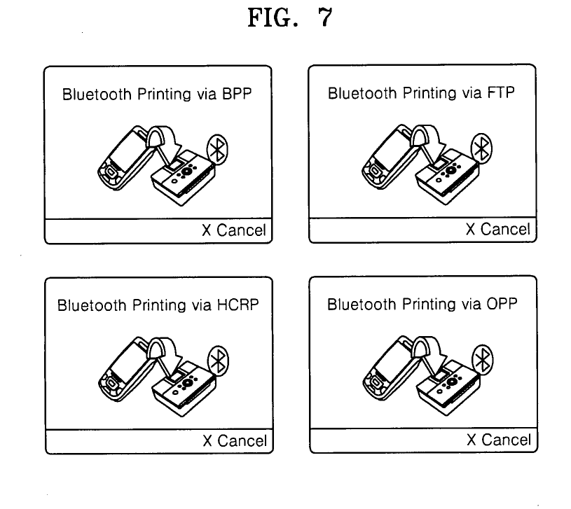

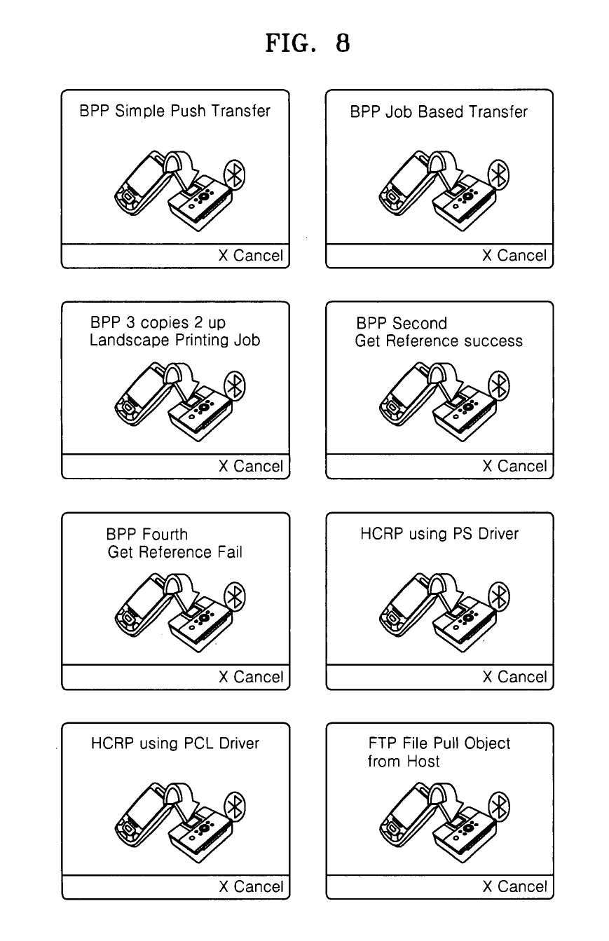

FIG. 5 is a block diagram of a printer 1000 to display job request information via Bluetooth according to an embodiment of the present invention. FIG. 6 is a flowchart of a method of displaying information in a printer to display job request information via Bluetooth according to an embodiment of the present invention. FIG. 7 shows various embodiments of a connection profile of a corresponding job displayed on a display unit of a printer according to an embodiment of the present invention. FIG. 8 shows various embodiments of information on a specific operation according to a corresponding profile displayed on a display unit of a printer according to an embodiment of the present invention.

As shown in FIG. 5, the printer 1000 to display the job request information according to the present embodiment includes a Bluetooth connector 1002 to connect the printer 1000 with a host 10′ (e.g., a mobile phone) via Bluetooth. A profile analyzer 1004 analyzes a Bluetooth profile to determine what the Bluetooth profile is (e.g., a basic printing profile (BPP), a file transfer protocol (FTP), an object push profile (OPP), a hardcopy cable replacement profile (HCRP), etc.). A profile handler 1005 handles an operation of the Bluetooth profile and determines a job status according to the corresponding profile. Display unit 1006 displays information of the profile analyzed by the profile analyzer 1004 and the job status according to the corresponding profile determined by the profile handler 1005. A controller 1008 controls the profile handler 1005, the display unit 1006, and the like, and for controlling all the jobs of the printer 1000. While not shown, a print unit prints the requested job onto a recording medium.

While described in terms of a mobile phone, it is understood that the host 10′ can be other devices, such as a camera, a computer, or other processor connected across the Bluetooth connection.

Here, it is noted that while the embodiments of the present invention are described as being Bluetooth enabled, it is understood that the apparatus and method of this invention can be applied to devices that are able to connect via other available wireless technologies and protocols, including other versions of Bluetooth and/or Wibree and can be implemented with short and long range wireless transmission protocols.

A method of displaying job request information in the aforementioned printer via Bluetooth will now be described with reference to FIGS. 6 to 8. As shown in FIG. 6, when a Bluetooth connection request is transmitted from the host 10′ to the printer 1000 (operation S100), the host 10′ connects to the printer 1000 via Bluetooth by the Bluetooth connector 1002 of the printer 1000 (operation S200). When the host 10′ is connected to the printer 1000, the host 10′ requests a job (e.g., a printing job or a file transfer job) of the printer 1000 (operation S300). The profile analyzer 1004 of the printer 1000 analyzes information on the requested job and/or information on a connection profile of the requested job and enables the information to be displayed on the printer display unit 1006 in various forms as shown in FIG. 7 (operation S400).

A drawing located at the first row and the first column of FIG. 7 illustrates a case where the profile of the job requested by the host is a Basic Printing Profile (BPP). The drawing located at the first row and the second column of FIG. 7 illustrates a case where the profile of the job requested by the host is a File Transfer Protocol (FTP). The drawing located at the second row and the first column of FIG. 7 illustrates a case where the profile of the job requested by the host is a Hard Copy Replacement Profile (HCRP). Lastly, the drawing located at the second row and the second column of FIG. 7 illustrates a case where the profile of the job requested by the host is an Object Push Profile (OPP). However, it is understood that these profiles are merely exemplary and that other profiles and/or combinations can be requested and/or displayed.

Then, as is described above, when a substantial job request is transmitted from the host 10′ to the printer 1000 via the aforementioned profile (operation S500), the profile handler 1005 of the printer 1000 handles an operation of the profile, determines the job status according to the profile, and as shown in FIG. 8, displays the status of the job on the display unit 1006 of the printer 1000. Specifically, the profile handler 1005 handles and confirms the information on a specific operation according to the profile and displays the information on the display unit 1006 of the printer 1000. While described as a display unit 1005 of the printer 1000, it is understood that the display unit 1006 can be connected to the printer 1000 in other aspects of the invention. Moreover, the status can include a failure of the job, completion of the job, and/or remaining pages to be printed.

The drawing located at the first row and the first column of FIG. 8 illustrates a case where the printer 1000 performs simple push transfer via BPP. The drawing located at the first row and the second column of FIG. 8 illustrates a case where the printer performs a BPP job based transfer. The drawing located at the second row and the first column of FIG. 8 illustrates a case where the printer performs a BPP 3 copies 2 up landscape printing job. The drawing located at the second row and the second column of FIG. 8 illustrates a case where the status of the printer is a “BPP second Get Reference success”. The drawing located at the third row and the first column of FIG. 8 illustrates a case where the status of the printer is a “BPP fourth Get Reference Fail”. The drawing located at the third row and the second column of FIG. 8 illustrates a case where the status of the printer is an “HCRP using PS Driver”. The drawing located at the fourth row and the first column of FIG. 8 illustrates a case where the status of the printer is an “HCRP using PCL Driver”. The drawing located at the fourth row and the second column of FIG. 8 illustrates a case where the status of the printer is an “FTP File Pull Object from Host”.

According to aspects of the present invention, a user may relatively easily check whether a host is connected with a printer via Bluetooth by using a profile suitable for the operation desired by the user. In addition, an undesired operation may be prevented by displaying the information on the specific operation according to the corresponding profile. While described in terms of displaying profiles, it is understood that the display can further include additional information identifying the type of operation and/or the operator.

As is described above, the printer to display the job request information via Bluetooth and the method of displaying the job request information in the printer prevent the undesired job operation by providing the information on the Bluetooth profile and the information on the job request.

In addition, in accordance with aspects of the invention, it is noted that the embodiments of the methods described herein may be executed by computer readable media having a program or programs stored thereon. While described in terms of a printer, it is understood that the invention can be implemented in apparatuses having scanning, copying, and/or faxing functions in addition to or instead of a printing function.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A printer to display information on a job that has been requested to be performed by a host via Bluetooth, the printer comprising:
a Bluetooth connector to connect the printer with the host via Bluetooth;
a profile analyzer to analyze a Bluetooth profile used in the connection with the host;
a profile handler to handle an operation of the Bluetooth profile and to determine a status of the job according to the profile;
a display unit to display information on the profile and the status of the job; and
a controller to control the Bluetooth connector, the profile analyzer, the profile handler, and the display unit to display the information and the status of the job.

2. The printer according to claim 1, wherein the status of the job determined by the profile handler includes information on a success or a failure of the job.

3. The printer according to claim 1, wherein the profile is one of a Basic Printing Profile (BPP), a File Transfer Protocol (FTP), an Object Push Profile (OPP), a Hardcopy Cable Replacement Profile (HCRP), or combinations thereof.

4. A printer to display information on a job transmitted to the printer via Bluetooth, the printer comprising:
a profile analyzer to analyze a Bluetooth profile of a Bluetooth connection to the printer; and
a display unit to display information on the Bluetooth profile that is analyzed by the profile analyzer.

5. The printer according to claim 4, further comprising:
a Bluetooth connector to connect the printer with a host in order to transmit the job via Bluetooth; and
a profile handler to handle an operation of the Bluetooth profile and to determine a status of the job.

6. The printer according to claim 5, wherein the status of the job determined by the profile handler includes information on a success or a failure of the job.

7. A method of displaying information on a job requested to be performed by a printer from a host via Bluetooth, the method comprising:
connecting the printer with the host via Bluetooth;
receiving at the printer the job to be performed from the host; and
displaying on a display unit the information on the job requested by the host and/or the information on a connection profile of the job requested by the host on a display unit.

8. The method according to claim 7, further comprising the printer displaying information on a specific operation according to the profile on the display unit.

9. The method according to claim 8, wherein the displaying of the information on the specific operation according to the profile comprises displaying information on a success or a failure of the job.

10. A method of displaying information on a job requested to be performed by a printer via Bluetooth, the method comprising:
receiving at the printer the request for the job from a host via a Bluetooth connection between the printer and the host; and
the printer identifying a Bluetooth profile of the connection between the printer and the host and displaying the identified Bluetooth profile.

11. The method according to claim 10, further comprising allowing the printer to display a success or a failure of the operation related to the profile.

12. A printer to display information on a job that a host that is connected to the printer via a wireless connection requests the printer to perform, the printer comprising:
a profile detector to detect a profile of the connection between the host and the printer; and
a display to display information on an operation of the determined profile and a status of the job being performed by the printer.

13. The printer according to claim 12, further comprising a display unit to display information on the profile and the status of the job.

14. The printer according to claim 12, wherein the profile is one of a Basic Printing Profile (BPP), a File Transfer Protocol (FTP), an Object Push Profile (OPP), a Hardcopy Cable Replacement Profile (HCRP), or combinations thereof.

15. A printer to display information on a job that a host that is connected to the printer via a wireless connection requests the printer to perform, the printer comprising:
a profile detector to detect a profile of the connection between the host and the printer; and
a display unit to display information on the detected profile of the connection.

16. The printer according to claim 15, further comprising a profile handler to handle an operation of the profile and to determine a status of the job, information relating to the operation of the profile and the status of the job being displayed by the display unit.

17. The printer according to claim 15, wherein the profile is one of a Basic Printing Profile (BPP), a File Transfer Protocol (FTP), an Object Push Profile (OPP), a Hardcopy Cable Replacement Profile (HCRP), or combinations thereof.

18. A method of displaying information on a job that a host, which is wirelessly connected to a printer, requests to be performed by the printer, the method comprising:
receiving the request for the performance of the job by the printer using the wireless connection; and
displaying a connection profile of the job and a status of the job.

19. The method of claim 18, wherein the connection profile is one of a Basic Printing Profile (BPP), a File Transfer Protocol (FTP), an Object Push Profile (OPP), a Hardcopy Cable Replacement Profile (HCRP), or combinations thereof.

20. A method of displaying information on a job that a host, which is wirelessly connected to a printer, requests to be performed by the printer, the method comprising:
identifying a profile of a wireless connection established between the printer and the host for use in accomplishing the job; and
displaying the identified profile.

21. A computer readable medium having a program stored thereon for use by one or more processors to execute the method of claim 7.

22. A computer readable medium having a program stored thereon for use by one or more processors to execute the method of claim 10.

23. A computer readable medium having a program stored thereon for use by one or more processors to execute the method of claim 18.

24. A computer readable medium having a program stored thereon for use by one or more processors to execute the method of claim 20.
